(19) United States
(12) Patent Application Publication
(10) Pub. No.: US 2001/0003977 A1
(43) Pub. Date: Jun. 21, 2001

(54) Fuel injection system for internal combustion engines and its method of control

(76) Inventors: Kenji Hayashi, Okazaki-shi (JP); Shohei Kuroda, Obu-shi (JP); Jun Yamada, Okazaki-shi (JP)

Correspondence Address: OLIFF & BERRIDGE, PLC, P.O. BOX 19928, ALEXANDRIA, VA, 22320, US

(21) Appl. No.: 09/733,040

(22) Filed: Dec. 11, 2000

(30) Foreign Application Priority Data
Dec. 13, 1999 (JP) HEI 11-353683

(51) Int. Cl. F02M 51/00

(52) U.S. Cl. 123/480

(57) ABSTRACT

A fuel injection system that can maintain a high accuracy level in adjusting the quantity of fuel injection in a system in which the first injector injects fuel in the liquid phase and the second injector injects fuel in the gaseous phase. The quantity of fuel injection of each injector is adjusted respectively in accordance with the fuel quantity required each time. The temperature of the first injector is estimated based on the temperature of the engine's cooling water and the temperature of the fuel in the fuel passage from the fuel tank to the first injector, and the quantity of vapor generated in the fuel passage is determined according to the estimated temperature and the fuel pressure in the fuel passage. The quantity of fuel injection of each injector is adjusted according to the determined quantity of vapor generated.

### INCORPORATION BY REFERENCE

The disclosure of Japanese Patent Application No. HEI 11-353683 filed on Dec. 13, 1999, including the specification, drawings and abstract is incorporated herein by reference in its entirety.

### BACKGROUND OF THE INVENTION

1. Field of the Invention

The invention relates to a fuel injection system for an internal combustion engine and its method of control.

2. Description of Related Art

The fuel injection system of an internal combustion engine supplies fuel to injectors of the internal combustion engine and controls the opening periods of the injectors in order to inject a proper quantity of fuel in accordance with the operating condition of the engine. The quantity of fuel injected is normally controlled by the fuel injection time.

A problem may occur, however, when an internal combustion engine, in which a liquefied fuel gas of a low boiling point such as LPG is used as the fuel to be pressurized and supplied to the injectors in the liquid phase, is restarted while the engine temperature is not sufficiently lowered (“high temperature restart”), and vaporization of the fuel is caused and a portion of the fuel remains in the system in the vapor phase even if the fuel is pressurized again. This causes the injectors to inject the fuel in a gas/liquid mixture state. If the injectors are operated with the same opening periods as in the case of a lower engine temperature, the engine may develop a shortage in the quantity of fuel injection during the period from the engine start to the initial idling period. This may cause an extremely lean air/fuel ratio condition, which in turn may cause poor starting and/or a rough idling condition. Although this fuel shortage problem may be solved by increasing the instructed quantity of fuel injection to match the fuel shortage, it is not a desirable method from the standpoint of the fuel quantity adjustment accuracy as it prolongs the fuel injection time under the gas/liquid mixture state.

As a consequence, a system disclosed by Japanese Patent Laid-Open Publication No. HEI 9-268948 divides the fuel supply system from the fuel tank to the injector into two systems. Under this scheme, the first fuel supply system supplies the fuel in the liquid state to the first injector. The second fuel supply system heats the fuel to vaporize it using the cooling water of the engine before it supplies the fuel to the second injector. The system is so designed that, if the cooling water temperature is lower than the lower limit at which the fuel can be heated for vaporization, the fuel injection is executed by the first injector, while if the cooling temperature is higher than the lower limit, the fuel injection is executed by the second injector.

In the fuel injection system described above, the shortage in the quantity of fuel injection can be prevented, as only the second injector injects the fuel and the first fuel injector is prevented from injecting gas/liquid mixture fuel when the cooling water temperature of the engine is high.

The problem of the proposed system is that it requires an additional device for heating the fuel to vaporize it by means of the engine co Sing water, thus making the system larger and more complex.

In order to cope with such a problem, an alternative method can be considered where the insufficient quantity of fuel in the gas/fuel mixture state supplied by the first injector is compensated by the gaseous state fuel injected by the second injector by means of supplying the gaseous phase fuel injector with the liquefied fuel stored in the fuel tank after converting liquefied fuel into a gaseous state.

However, the quantity of vapor developed in the liquid phase fuel injector during high temperature restarting of the engine changes with various factors such as ambient temperature during engine restarting. Hence, fuel quantity adjustment accuracies of the first and second injectors during high temperature engine restarting may become a new issue.

### SUMMARY OF THE INVENTION

It is an object of the invention to provide fuel injection system for internal combustion engine to maintain a high level of fuel quantity adjustment accuracy in a first injector that injects the fuel in the liquid phase and a second injector that injects the fuel in the gaseous phase to supply the fuel to the engine.

In order to achieve the foregoing object, the fuel injection system according to various exemplary embodiments of the invention includes a fuel tank, a first fuel injector that injects in a liquid state a fuel stored in the fuel tank, a second fuel injector that injects in a gaseous state the fuel stored in the fuel tank, and a controller. The controller adjusts the quantities of fuel injected by the first and second injectors to meet a quantity of fuel required by an internal combustion engine. The controller also estimates the temperature of the first injector based on the temperature of the internal combustion engine, and the temperature of the fuel inside the fuel passage from the fuel tank to the first injector. The controller adjusts the fuel injection quantities of the first and second injectors based on the estimated temperature of the first injector.

By estimating the temperature of the first injector based on the engine temperature and the fuel temperature inside the fuel passage, the fuel injection system takes into account the heat removed from the first injector itself by the fuel during fuel injection. Thus, the temperature of the first injector can be estimated more accurately in this case compared to a case where the temperature is estimated based only on the engine temperature.

Moreover, the controller can be configured to determine the quantity of vapor generated in the fuel passage based on the estimated temperature of the first injector and the fuel pressure in the fuel passage to adjust the quantities of fuel to be injected by the first and second injectors respectively.

By determining the quantity of vapor generated in the fuel passage based on the estimated temperature of the first injector and the fuel pressure in the fuel passage, in addition to the estimation of the temperature of the first injector, the condition of the fuel to be injected by the first injector can be grasped more precisely. Therefore, it is possible for the system to maintain a high level of accuracy in adjusting the quantities of fuel to be injected by the first and second injectors in correspondence with the quantity of fuel required by the engine under varying conditions by means of determining the quantity of fuel to be injected by each injector including the necessity of assistance by the second injector based on the determination of the vapor generation. Moreover, the fuel injection system provides a simpler system composition, as it does not require a device for vaporizing the fuel.

Furthermore, it is possible to include consideration of the nature of the fuel in the fuel tank, i.e., aptness for developing vapor, in the determination of the quantity of vaporization.

It should make the vaporization determination more accurate, which in turn should make the adjustment of the fuel quantity to be injected by each injector more accurate.

The nature of the fuel changes with the temperature and pressure of the fuel. Therefore, the nature of the fuel can be determined based on the temperature and pressure of the fuel inside the fuel tank.

In the fuel injection system, the controller can be configured in such a way as to set the quantity of fuel injection of the second injector to zero, if the vaporization is below a preset level.

The stability of the quantity of fuel injection reduces when the fuel enters a gas/liquid mixture state, and also reduces when the vapor generation in the injected fuel increases. On the contrary, the fuel quantity adjustment accuracy increases if the fuel is injected in the liquid phase, which has less fluctuation of concentration compared to the fuel in the gaseous phase. As a result, it is easier to maintain a higher level of accuracy in the fuel quantity adjustment by injecting the fuel only through the first injector in case the quantity of vapor generation is small.

The controller can also be configured in such a way as to estimate whether any vapor exists in the fuel passage based on the fuel temperature and pressure in the fuel passage and adjust the quantities of fuel to be injected by the first and second injector respectively based on the estimated vapor presence when the determined quantity of vapor generation exceeds a certain preset value.

Even if vapor is generated in the fuel passage, the generated vapor will gradually be scavenged with the progress of actual fuel injection operations. Therefore, when it is noted that vapor has been generated above a certain level of quantity, the quantity of fuel injection of each injector can be adjusted properly according to the fuel condition in the fuel passage by means of controlling the quantity of fuel injection based on the presence of vapor, in other words, whether the vapor scavenging is completed or not.

In the above fuel injection system, the controller can be configured in such a way that when it is estimated that some vapor exists in the fuel passage, the quantity of fuel injection of the first injector is set to zero; on the other hand, when it is estimated that no vapor exists in the fuel passage, the fuel injection is started with the first injector alone and then the ratio of the quantity of fuel injection of the first injector against that of the second injector is gradually increased.

If the insufficiency of the quantity of fuel injection of the first injector grows too much due to the excessive generation of vapor, the fuel injection is switched to injection by the second injector only. In other words, it prevents the actual injection quantity from deviating substantially from the required fuel quantity. Moreover, when it is estimated that the vapor does not exist any more after injecting the fuel for a while, in other words, the vapor scavenging is completed, fuel injection by the first injector is added, and the ratio of fuel injection by the first injector is gradually increased. In other words, as the fuel injection becomes predominantly by means of liquid phase fuel, which has a relatively smaller variation of concentration compared to the gaseous phase fuel, a higher level of quantity adjustment accuracy can be maintained.

### BRIEF DESCRIPTION OF THE DRAWINGS

FIG. 1 is an outline schematic drawing of the fuel injection system according to the invention;

FIG. 2 is a timing chart showing the changes in the injector temperature and the fuel temperature in accordance with fuel injection;

FIG. 3 shows a map used for determining the propane ratio of the fuel in the fuel tank;

FIG. 4A and FIG. 4B are graphs each indicating the relation between the vapor quantity in the fuel passage, the estimated first injector temperature, and the fuel delivery pressure;

FIG. 5 shows a map used for determining the vapor correction factor based on the first injector temperature and the fuel pressure;

FIG. 6 is a flow chart showing the routine for determining the propane ratio of the fuel in the fuel tank;

FIG. 7 is a flow chart showing the routine for determining the use of the second injector;

FIG. 8 is a flow chart showing the routine for determining whether the vapor in the fuel passage is completely scavenged;

FIG. 9 is a flow chart showing the routine for determining the fuel injection quantities of both injectors;

FIG. 10 is a flow chart showing the routine for determining the fuel injection quantities of both injectors; and

FIG. 11 is a timing chart showing an example of the fuel injection performed by the respective injectors.

### DETAILED DESCRIPTION OF PREFERRED EMBODIMENTS

A fuel injection system for internal combustion engines according to the invention which is applied to a liquefied fuel gas engine will be described below as a preferred embodiment.

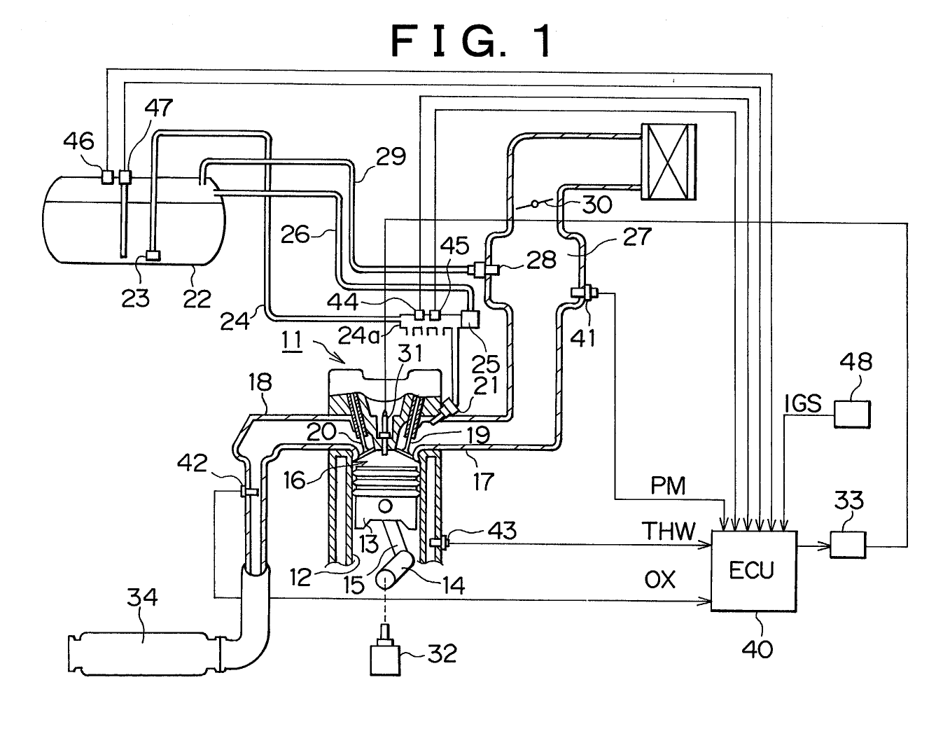

First, the construction and outline of the fuel injection system of this embodiment will be described referring to FIG. 1. As shown in FIG. 1, the system is constructed around a liquefied fuel gas internal combustion engine (“engine”) 11. The engine 11 has a piston 13 in a cylinder 12. The piston 13 is connected via a connecting rod 15 to a crankshaft 14, which is an output shaft of the engine 11, and the connecting rod 15 converts the reciprocating motion of the piston 13 to the rotation of the crankshaft 14.

A starter motor 32 is attached to the crankshaft 14 such that the motor power is transmitted only when the engine 11 is started. When the engine 11 is to be started, the starter motor 32 is energized to provide a rotating force to the crankshaft 14.

A combustion chamber 16 formed upward of the piston 13 communicates with a intake passage 17 and an exhaust passage 18. The communicating portion between the combustion chamber 16 and the intake passage 17 is opened or closed by an intake valve 19. The communicating portion between the combustion chamber 16 and the exhaust passage 18 is opened or closed by an exhaust valve 20.

A first injector 21 is provided in the intake passage 17 of the engine 11 that injects liquid state fuel. The first injector 21 is located in the vicinity of the combustion chamber 16 with its tip directed toward an intake valve 19 and supplies liquid state fuel to the combustion chamber 16 of the engine 11 in accordance with its valve opening action.

The first injector 21 is connected via a delivery passage 24 to a feed pump 23 located inside a fuel tank 22. The liquid state fuel held in the fuel tank 22 is fed under pressure by the feed pump 23, and this pressurized fuel is supplied to the first injector 21 through the delivery passage 24 and a delivery pipe 24a. A straight four cylinder engine is to be used as the engine 11 in this embodiment, so that the first injectors of other cylinders (not shown) are to be connected in a similar manner to the delivery pipe 24a.

A relief valve 25 is provided in the delivery pipe 24a. Fuel with a pressure exceeding the predetermined level is returned to the fuel tank 22 via the relief valve 25 and the return passage 26. In other words, the fuel pressure in the delivery pipe 24a is maintained to be approximately constant to adjust the fuel quantity supplied by injection during the open valve period of the first injector 21.

A surge tank 27 provided upstream of the intake passage 17 is equipped with a second injector 28 that injects the fuel in the gaseous state. The second injector 28 is connected to the fuel tank 22 via a delivery passage 29 and injects the fuel, which existed in the tank 22, in a gaseous state, to the surge tank 27 when the valve opening of the second injector 28.

In the fuel injection system of this embodiment, the fuel is injected into the engine 11 by means of the two separate systems of injectors, the first injector 21 and the second injector 28.

The surge tank 27 is equipped with an intake pressure sensor 41 to detect the pressure (intake pressure) inside the intake passage 17. The intake pressure detected by this intake pressure sensor 41 is taken into an electronic control unit (ECU) 40 as the intake pressure signal PM.

On the upstream of the surge tank 27 provided is a throttle valve 30 that controls the cross section of the passage of the intake passage 17 based on the operation of the accelerator pedal. The volume of air taken into the combustion chamber 16 is adjusted by the degree of opening of the throttle valve 30.

Due to these compositions on the intake passage 17, an air/fuel mixture consisting of the liquid state fuel injected by the first injector, the gaseous state fuel injected by the second injector 28, and the intake air controlled by the throttle valve 30 is introduced into the combustion chamber 16 of the engine 11 through the intake valve 19.

When the ignition signal is applied by means of an igniter 33 to a sparkplug 31, whose tip is exposed in the combustion chamber 16, to ignite the air/fuel mixture introduced into the combustion chamber 16, the combustion stroke follows the ignition and delivers driving power to the crankshaft 14.

At the end of the combustion stroke, the combusted gas is discharged from the combustion chamber 16 to the exhaust passage 18 through the exhaust valve 20, and then to the outside after having been cleaned by a ternary catalytic converter 34 provided on the exhaust passage 18.

An air/fuel ratio sensor 42 is incorporated in the exhaust passage 18 in order to determine whether the air/fuel mixture supplied to the combustion chamber 16 is on the lean side or on the rich side of the theoretical air/fuel ratio based on the oxygen concentration in the exhaust gas. The detection signal of the air/fuel sensor 42 is taken into the ECU 40 as the air/fuel ratio signal OX.

A water temperature sensor 43 is provided on the engine 11 in order to detect the temperature of the cooling water that flows through the water jacket. The detection signal of the water temperature sensor 43 is taken into the ECU 40 as the cooling water temperature signal THW and used for various controls as a parameter representing the engine temperature of the engine 11.

The delivery pipe 24a, to which the first injector 21 is connected, is provided with a pressure sensor 44 for detecting the fuel pressure in the pipe and the temperature sensor 45 for detecting the fuel temperature. The detection signals from the pressure sensor 44 and the temperature sensor 45 are both taken into the ECU 40 as the fuel delivery pressure signal DP and the fuel delivery temperature signal DT respectively. The conditions of the fuel supplied to the first injector 21 are monitored based on these signals DP and DT.

The fuel tank 22 is provided with a pressure sensor 46 for detecting the pressure of the vaporized fuel in the fuel tank 22 and a temperature sensor 47 for detecting the temperature of the liquid state fuel in the fuel tank 22. The detection signals from the pressure sensor 46 and the temperature sensor 47 are both taken into the ECU 40 as the in-tank fuel pressure signal TP and the in-tank fuel temperature signal TT respectively. The characteristics of the fuel in the fuel tank 22 are monitored based on these signals TP and TT.

An ignition switch 48 is provided in the vehicle's cabin (not shown) for starting the engine 11. When the switch 48 is operated, the ignition signal IGS is outputted and the signal IGS is taken into the ECU 40. The starter motor 32 is energized when the switch 48 is turned on, and drives the engine 11 to start it.

The ECU 40 that controls various parts of the engine 11 consists of, for example, a microcomputer and performs various controls, for example, the opening and closing of the first injector 21 and the second injector 28 based on various signals it takes in.

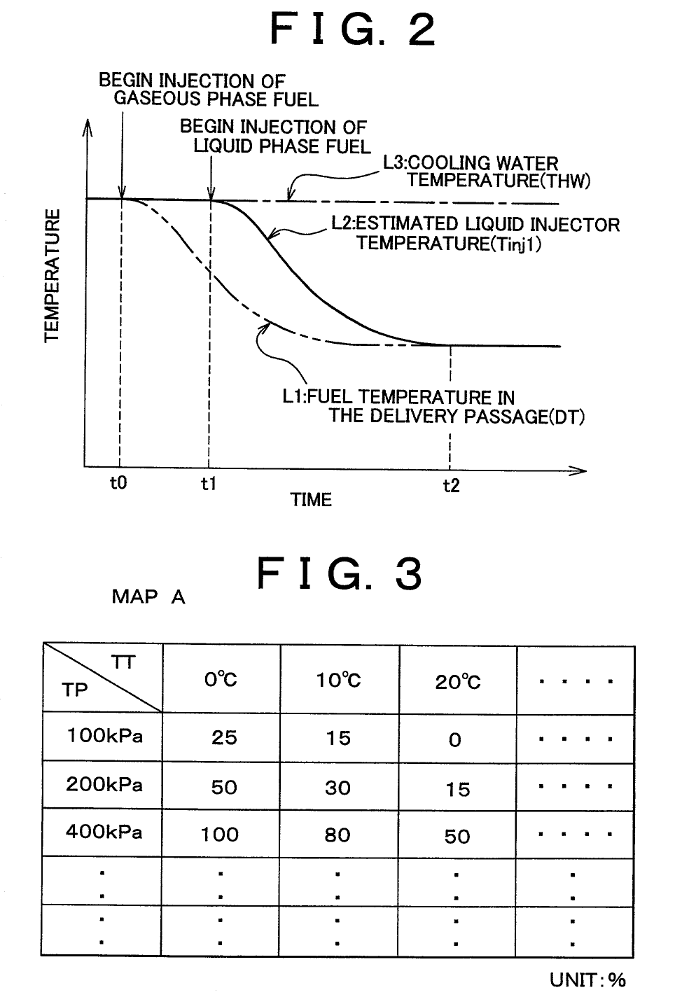

In a system like the one described above, the injection of the gaseous state fuel by the second injector 28 is executed first when the engine 11 is restarted while the engine's temperature is still high as shown in FIG. 2, followed by the injection of the liquid state fuel by the first injector 21.

When the injection of the gaseous state fuel by the second injector 28 begins (timing t0 in the graph), the fuel vaporized in the fuel tank 22 is supplied to the second injector 28 through the delivery passage 29. As a result, the temperatures of both the gaseous state fuel and the liquid state fuel in the fuel tank 22 gradually drop in relation to the amount of gaseous fuel supplied. Furthermore, the temperature of the fuel in the delivery passage 24 and the delivery pipe 24a through which the fuel from the fuel tank 22 is fed under pressure (refer to the line L1 between the timings t0 and t1 shown in FIG. 2). Consequently, the vapor quantity in the fuel also reduces.

When the fuel injection by the first injector 21 begins (timing t1 in the graph), a heat exchange occurs between the first injector 21 and the fuel supplied through the delivery passage 24 and the delivery pipe 24a, the temperature inside the first injector 21 gradually drops (line L2 between the timings t1 and t2 of the graph).

However, the temperature of the cooling water of the engine 11 will not be affected as shown by the line L3 of the graph in FIG. 2. In other words, the temperature of the first injector 21 will be lower than the cooling water temperature after the heat exchange mentioned above.

Thus, even if the first injector 21 is at a high temperature when the engine 11 is started, the temperature gradually drops as the fuel is injected by the first injector 21 and the vapor quantity inside reduces as well. In other words, it is impossible to accurately adjust the fuel injection quantities (injection time periods) of the first injector 21 and the second injector 28 based on temperature if only the cooling water temperature is monitored as a guide for the temperature of the first injector 21 and the second injector 28.

Therefore, in the fuel injection system according to this embodiment, the temperature of the first injector 21 is estimated based on the cooling water temperature and the fuel temperature in the fuel passage (delivery passage 24 and the delivery pipe 24a) at the time of starting the engine 11. The quantity of the vapor generated in the fuel passage is determined based on the estimated temperature, and the fuel injection quantities for the first and second injectors 21 and 28 will be controlled based on the determined quantity of vapor generated.

First, the temperature Tinj1 of the first injector 21 is determined in this system according to the formula (1) shown below based on the cooling water temperature THW, fuel delivery temperature DT, and the count value CVAPER of the injection time counter of the first injector 21:

Tinj1=THW−(THW−DT)×CVAPER/Ta (1)

where Ta represents upper limit of the count value CVAPER.

Since the first injector 21 is located near the combustion chamber 16 of the engine 11, its temperature changes with the temperature of the engine 11. The temperature of the first injector 21 changes due to the heat of the fuel in the fuel passage as well.

Therefore, the estimation of the first injector temperature Tinj1 in this embodiment takes into consideration the temperature of the fuel in the delivery pipe 24a (fuel delivery temperature DT) in addition to the cooling water temperature THW, which is the temperature of the engine 11 as shown in the formula (1). As a result, it is possible to achieve more accurate temperature estimation compared to the case of estimating the temperature Tinj1 based on only the cooling water temperature THW.

If fuel injection by the first injector 21 is continued for a while, the temperature of the first injector 21 stabilizes at the temperature of the fuel being fed under pressure (fuel delivery temperature DT) (refer to the line L2 after the timing t2 in FIG. 2). Thus, the temperature estimation according to the formula (1) is based on the fuel delivery temperature DT as well.

The injection time counter is a counter for measuring the period of time during which the fuel is injected by the first injector 21. In the formula (1), the temperature of the first injector 21 is assumed to be stabilized when the count value CVAPER of the counter reaches the upper limit Ta. The count value CVAPER is set to zero at the time of the initialization of the ECU 40, and is incremented by a predetermined increment at each specified time interval (e.g., every 50 millisecond) when the fuel injection by the first injector 21 begins. In addition, the upper limit Ta of the count value CVAPER is set appropriately based on experimental data, etc.

Since the estimation of the first injector temperature Tinj1 according to the formula (1) takes the injection time counter value CVAPER into consideration, the estimated temperature Tinj1 can be suitably applied to estimate the temperature drop of the first injector 21 due to the continued fuel injection.

The quantity of vapor generation of the fuel supplied to the first injector 21 changes with the pressure and nature (ratio of the liquid state portion of the fuel, i.e., propane ratio) of the fuel in the fuel passage.

The propane ratio can be determined based on the fuel temperature (in-tank fuel temperature TT) and the fuel pressure (in-tank fuel pressure TP) in the fuel tank 22. The saturated vapor properties change as the properties of the fuel change, so that the propane ratio of the fuel in the fuel tank 22 can be specified based on the in-tank fuel temperature TT and the in-tank fuel pressure TP.

The map A shown in FIG. 3 is used for determining the propane ratio PP based on the in-tank fuel temperature TT and the in-tank fuel pressure TP. As can be seen from FIG. 3, the propane ratio PP is smaller when the in-tank fuel temperature TT is higher, and larger when the in-tank fuel pressure TP is higher. In other words, the higher the pressure of the fuel in the fuel tank 22 is, the less vapor generated in the fuel passage occurs, and the higher the fuel temperature is, the more vapor generated in the fuel passage occurs.

In determining the quantity of vapor generation in the fuel passage, the determined quantity of vapor generated becomes more accurate by taking such a property (propane ratio PP) of the fuel in the fuel tank 22 into consideration. This map A is determined from the relation between the saturated vapor pressure of the fuel and is stored in the memory of the ECU 40 in advance.

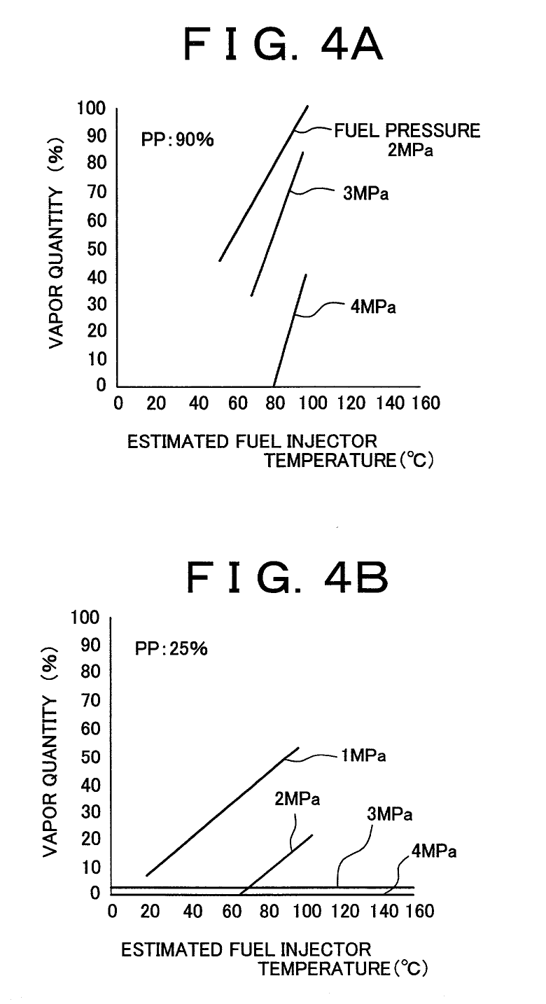

FIG. 4A and FIG. 4B are graphs showing the results of inspection concerning the relationship between the vapor generated in the fuel passage, estimated first injector temperature Tinj1, measured fuel pressure (fuel delivery pressure DP), and the propane ratio determined from them. FIG. 4A shows the case of a fuel whose propane ratio PP is 90%, while FIG. 4B shows the case of a fuel whose propane ratio PP is 25%.

As can be seen from FIG. 4A and FIG. 4B, the greater the first injector's estimated temperature Tinj1 is, the greater the quantity of vapor generated in the fuel passage is, and the smaller the fuel delivery pressure DP is, the greater the quantity of vapor generated in the fuel passage is. Thus, the quantity of vapor generated in the fuel passage changes with parameters such as the estimated first injector temperature Tinj1, the fuel delivery pressure DP, and the propane ratio PP.

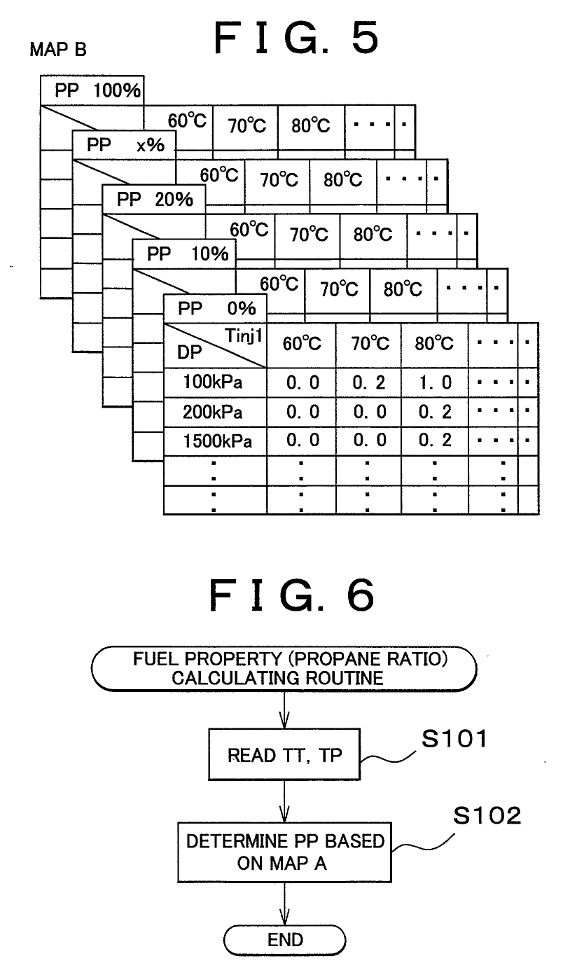

Consequently, another map is provided shown as the map B in FIG. 5 in order to determine the quantity of vapor generation in the fuel passage based on those parameters in this fuel injection system of this embodiment. The map B is stored in advance in the memory of the ECU 40.

The map B shows the relationship between the fuel delivery pressure DP and the estimated first injector temperature Tinj1 as shown in a two dimensional map for each specified increment of the propane ratio PP (e.g., each 10%) determined in the above. In order to use this map B for determining the quantity of vapor generation in the fuel passage, first, select the two dimensional map of the fuel pressure vs. estimated injector temperature that corresponds to the propane ratio PP determined in the above, and then determine the quantity of vapor generation (vapor correction factor KV) that corresponds to the fuel delivery pressure DP and the estimated first injector temperature Tinj1 based on the selected map.

The quantity of vapor generation in the fuel passage in this system is determined as a vapor correction factor KV in such a way that:

(a) the greater the estimated first injector temperature Tinj1 is, the greater it becomes;

(b) the smaller the fuel delivery pressure DP is, the greater it becomes; and

(c) the greater the propane ratio PP is, the greater it is.

Next, a determination is made as to whether the second injector 28 should be used, i.e. whether the assistance by the second injector 28 is required, based on the vapor correction factor KV determined in the above.

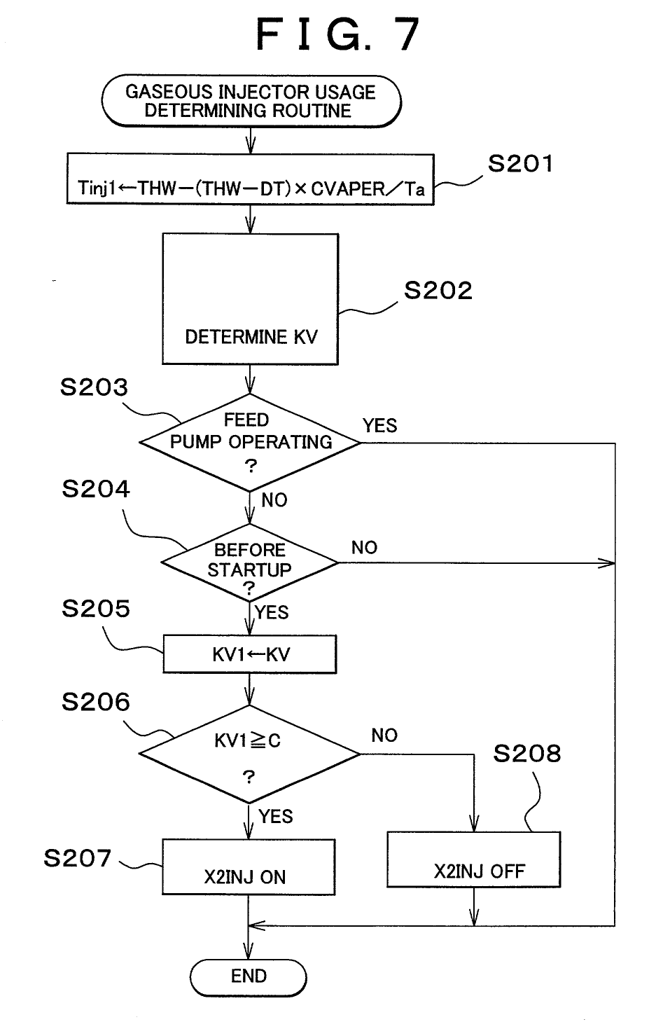

The procedures of the determination based on the vapor correction factor KV will be described below referring to FIG. 6 and FIG. 7. FIG. 6 shows a routine for determining the propane ratio PP and this routine is executed by the ECU 40 as an interruption process at a certain predetermined interval (e.g., 1 minute).

In this processing, the in-tank fuel temperature TT and the in-tank fuel pressure TP are read (step S101). The propane ratio PP of the fuel in the fuel tank 22 is determined by referencing the in-tank fuel temperature TT and the in-tank fuel pressure TP with the map A (refer to FIG. 3) (step S102). The ECU 40 stores the determined propane ratio PP into the memory and terminates this routine for the time being.

Next, a determination is made as to whether the second injector 28 should be used based on the determined propane ratio PP, etc. FIG. 7 shows the routine for determining whether the second injector 28 should be used and is executed by the EUC 40 as an interruption process at a certain time interval (e.g., 50 milliseconds).

In this routine, the first step is the estimation of the first injector temperature Tinj1 based on the formula (1) (step S201).

Next, the propane ratio PP is read, and the vapor correction factor KV is determined according to map B (refer to FIG. 5) from the propane ratio, the estimated first injector temperature Tinj1 and the measured fuel delivery pressure DP (step S202).

Next, determinations are made as to whether the feed pump 23 is operating (step S203), and whether the engine 11 has started (step S204). If the feed pump 23 is operating, the fuel delivery pressure DP as well as the vapor correction factor KV change. The determination on the necessity of using the second injector 28 needs to be done only once after the ignition switch 48 is turned on. Therefore, this system is designed in such a way that the determination on the necessity of the use of the second injection 28 is done only once using the vapor correction factor KV before the driving of the feed pump 23 after the ignition switch 48 is turned on. Therefore, if it is recognized that the feed pump 23 is operating, or if the engine 11 is in the starting operation or has been started up (step S203: YES or step S204: NO), the process of this routine terminates for the time being.

On the other hand, if the feed pump 23 has not been started and it is also before the start up of the engine 11 (step S203: NO and step S204: YES), the determined vapor correction factor KV is stored in the memory in the ECU 40 as the pre-start up vapor correction factor KV1 (step S205).

A determination is made at this point as to whether the pre-startup vapor correction factor KV1 is greater than the predetermined value C (steps S206). The predetermined value C is a value used for determining whether there is a possibility that the air/fuel ratio of the air/fuel mixture supplied to the combustion chamber 16 will be substantially disturbed due to the vapor contained in the injected fuel (whether the vapor content of the fuel in the fuel passage is large) when the fuel injection is done solely by the first injector 21.

If it is determined that the vapor in the fuel may disturb the air/fuel ratio of the air/fuel mixture (step S206: YES), the second injector usage flag X2INJ is turned on, and the use of the second injector 28 is determined to be necessary (step S207).

On the other hand, if the vapor in the fuel is determined to not disturb the air/fuel ratio of the air/fuel mixture (step S206: NO), the second injector usage flag X2INJ is turned off, and the use of the second injector 28 is determined unnecessary (step S208).

After the second injector usage flag X2INJ is operated as described above, the process of this routine is terminated for the time being.

If the temperature of the fuel in the fuel passage is high (when the fuel delivery temperature DP value is large), the fuel in the fuel passage repeats the phase transition of vapor generation and extinction, and the fuel pressure (fuel delivery pressure DP) is in an unstable condition. Moreover, the fuel delivery temperature DT gradually drops after the fuel injection is started by the second injector 28. With the drop of this fuel delivery temperature DT, the unstable condition of the fuel delivery pressure DP due to vapor generation and extinction in the fuel also disappears. The fuel delivery temperature DT subsequently becomes stable upon reaching its lowest level. It can be determined that the vapor in the fuel inside the fuel passage has been scavenged after the fluctuations of the fuel delivery pressure DP and the fuel delivery temperature DT have subsided.

The system performs a process of determining the presence of vapor in the fuel inside the fuel passage through monitoring of the variations of the fuel delivery pressure DP and the fuel delivery temperature DT.

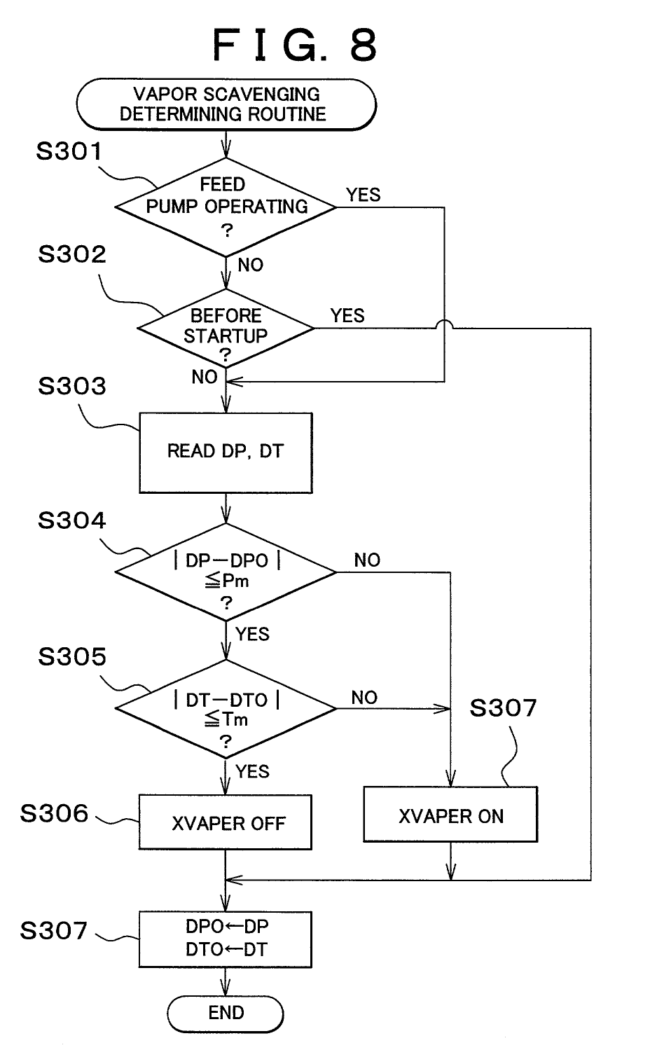

The procedure of determining whether the vapor in the fuel passage has been scavenged will be described referring to FIG. 8. The procedure shown in FIG. 8 is executed as an interruption procedure at a certain time interval (e.g., 1 second) by the ECU 40.

The first step in the process of this routine is a determination as to whether the feed pump 23 has been started (step S301) and whether it is before the startup of the engine 11 (step S302).

If it is before the startup of the feed pump 23, the fuel has not been fed through the delivery passage 24. Therefore there is no variation in the fuel delivery temperature DT and the fuel delivery pressure DP. Consequently, monitoring of the fuel delivery temperature DT and the fuel delivery pressure DP will show only a small variations and thus may lead to a mis-conclusion that the vapor in the delivery passage 24 has been scavenged although in reality the vapor has not been scavenged yet. Also, no variation occurs in the fuel delivery temperature DT and the fuel delivery pressure DP before starting the engine 11.

Therefore, in the case where it is determined that the feed pump 23 is not operating and the engine 11 has not been started up (step S301: NO and step S302: YES), it jumps to step S308 without determining the presence of vapor. At the step S308, a process of updating the measured fuel delivery temperature DT and the measured fuel delivery pressure DP as the values of previous detection cycle, i.e., DTO and DPO, and the process of this routine is terminated for the time being. The values of previous detection cycle, DTO and DPO, will be used in the process of this routine in the next round as the values of previous detection cycle.

On the other hand, if it is determined that the feed pump 23 is operating (step S301: YES), or if the engine 11 is being started up or has been started up (step S302: NO), a determination is made as to whether vapor exists in the fuel passage by means of the process of the step S303˜step S305.

First, the fuel delivery pressure DP and the fuel delivery temperature DT are read at the step S303.

Next, a determination is made according to the formula (2) below whether the difference between the fuel delivery pressure of the previous detection cycle (updated) DPO and the fuel delivery pressure detected in the current cycle DP is smaller than the predetermined value Pm (e.g., 0.05 MPa), i.e., whether the pressure change is small (step S304).

|DP−DPO|≦Pm (2)

In step S305, a detemination is made according to the formula (3) below whether the difference between the fuel delivery temperature of the previous detection cycle (updated) DTO and the fuel delivery temperature detected in the current cycle DT is smaller than the predetermined value Tm (e.g., 5° C.), i.e., whether the temperature change is small.

|DT−DTO|≦Tm (3)

If the changes of both the fuel delivery pressure DP and the fuel delivery temperature DT are smaller than the specified values Pm and Tm (YES to both steps S304 and S305), it is determined that the vapor in the fuel passage has been scavenged, and the incomplete vapor scavenging flag XVAPER will be turned off (step S306).

On the other hand, even if one of the variations of the fuel delivery pressure DP and the fuel delivery temperature DT is larger than the specified values Pm and Tm (NO to either one of the steps S304 and S305), it is determined that the vapor in the fuel passage has not been scavenged, and the incomplete vapor scavenging flag XVAPER will be turned on at the step S307.

After the incomplete vapor scavenging flag XVAPER is operated as described above, the fuel delivery pressure DP and the fuel delivery temperature DT are updated as the previous detection values DPO and DTO (step S308) and the process of this routine is terminated for the time being.

Following the above steps, the control of the fuel injection quantities of the first injector 21 and the second injector 28 is executed based on the second injector usage flag X2INJ and the incomplete vapor scavenging flag XVAPER operated as described above.

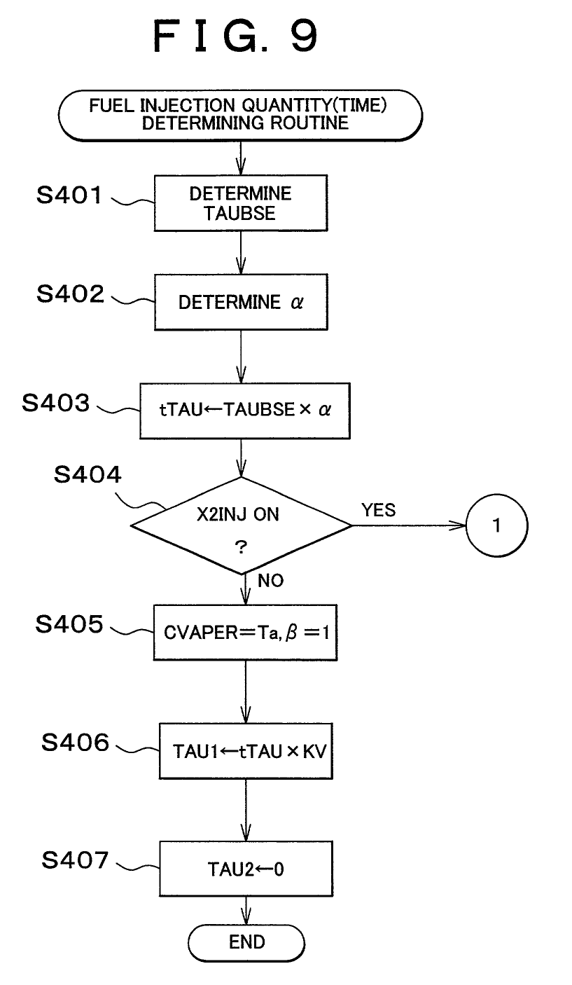

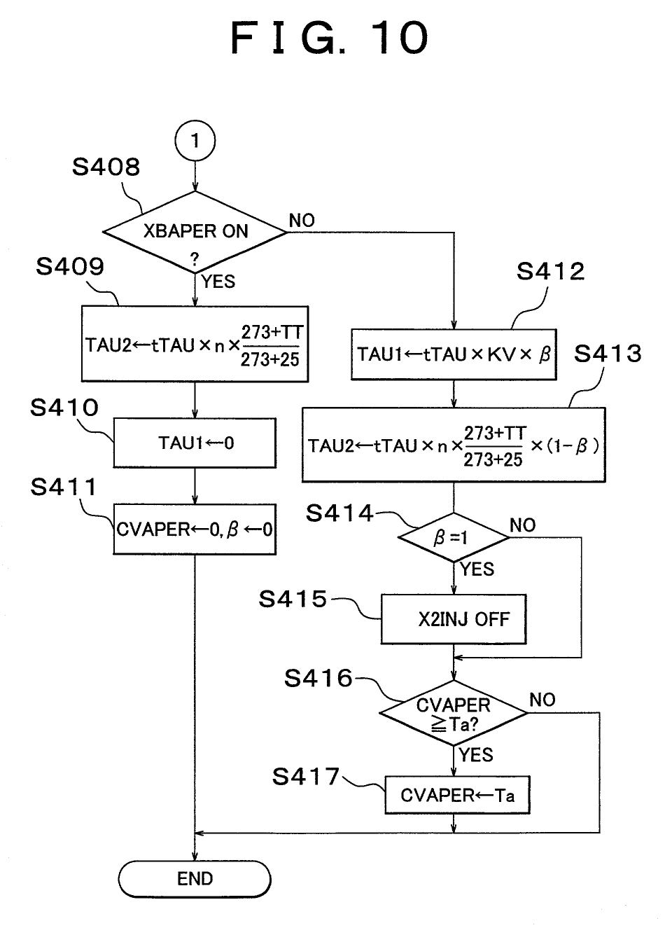

The procedures of determining the fuel injection quantities (time) of the injectors 21 and 28 will be described below referring to FIG. 9 and FIG. 10. The procedures shown in FIG. 9 and FIG. 10 are executed by the ECU 40 during the determination of the fuel injection time.

The first step of the procedures of this routine is to determine the basic fuel injection time TAUBSE based on the operating condition of the engine 11 (step S401).

The correction factor a that is used to correct the basic fuel injection time TAUBSE in accordance with the operating environment of the engine 11 is determined (step S402). The correction that is implemented in accordance with the operating environment of the engine 11 include an increasing correction after engine startup, an increasing correction for engine warm up, an increasing correction for output, an increasing correction for acceleration, and a reducing correction for deceleration.

Next, the fuel injection time tTAU, which is the total injection time of the injectors 21 and 28, is determined according to the following formula (4) (step S403):

tTAU=TAUBSE×α (4)

A determination is made as to whether the second injector usage flag X2INJ, which is operated as described above, is turned on, i.e., if the use of the second injector 28 is necessary (step S404).

If it is determined here that the use of the second injector 28 is not necessary (step S404: NO), the next steps S405˜S407 are executed in order to execute fuel injection with only the first injector 21.

First, the count value CVAPER of the injection time counter of the first injector 21 and the fuel injection ratio β of the first injector 21 are set to their upper limits (step S405).

Next, the fuel injection time TAUL of the first injector 21 is determined according to the formula (5) (step S406).

TAU1=tAUBSE×KV (5)

Consequently, the determined fuel injection time tTAU is corrected by the vapor correction factor KV and the fuel injection by the first injector 21 will be executed according to the corrected fuel injection time TAU1.

Next, the fuel injection time TAU2 of the second injector 28 is set to zero. In this case, no fuel injection will be performed by the second injector 28 and the fuel is injected only by the first injector 21.

Thus, the fuel injection by the second injector 28 is not performed and the quantity of fuel injection is adjusted only by the fuel injection time TAU1 of the first injector 21, if it is determined that the second injector usage flag X2INJ is turned off, i.e., the vapor correction factor KV in the fuel passage is small (vapor generated in the fuel passage is small).

On the other hand, if it is determined that the use of the second injector 28 is necessary (step S404: YES), a determination is made as to whether any vapor exists in the fuel passage based on the incomplete vapor scavenging flag XVAPER (FIG. 10, step S408). If it is determined that vapor exists (step S408: YES), the quantity of fuel injection is adjusted only by the second injector 28 (steps S409˜S411).

If it is determined that vapor exists in the fuel passage, the fuel injection time TAU2 of the second injector 28 is determined according to the formula (6) below:

TAU 2=tTAU×n×(273+TT)/(273+25) (6)

The fuel injection time tTAU is determined as the fuel injection time (valve opening time) applicable in the case of injecting the fuel in the liquid state. Therefore, it is necessary to convert it to the fuel injection time for injecting the fuel in the gaseous state if it is necessary to determine the fuel injection time TAU2 based on the fuel injection time tTAU.

Therefore, a conversion factor n is introduced in the formula (6) which is determined from the flow quantity of the fuel injected by the first injector 21, the flow quantity of the fuel injected by the second injector 28, and the gaseous expansion coefficient of the fuel. The third term (273+TT)/(273+25) of the formula (6) converts the fuel injection time to a time corresponding to the gaseous expansion coefficient of the fuel in the gaseous state in accordance with the change of the fuel temperature in the tank (in-tank fuel temperature TT).

The fuel injection time tTAU determined as described in the above (step S403) is converted into the fuel injection time for the gaseous state injection based on the conversion factor n and the gaseous expansion coefficient, and the fuel injection by the second injector 28 is executed for the fuel injection time TAU2 obtained by the conversion.

At the step S410, the fuel injection time TAU1 of the first injector 21 is set to zero. Then, at the step S411, the fuel injection time counter (CVAPER) of the first injector 21 and the fuel injection ratio β of the first injector 21 determined as described above are both reset to zero.

Thus, if it is determined that vapor exists in the fuel passage, the fuel is injected by the second injector 28 alone. Therefore, if the vapor in the fuel passage has not been fully scavenged and a substantial insufficiency of fuel supply occurs due to the vapor included in the fuel being injected by the first injector 21, the quantity of fuel injection is adjusted by adjusting only the fuel injection time TAU2 of the second injector 28.

If it is determined that no vapor exists in the fuel passage (step S408: NO), the fuel injection time TAU1 for the first injector 21 and the fuel injection time TAU2 for the second injector 28 are determined based on the following formulas (7) and (8) based on the fuel injection time tTAU, vapor correction factor KV, fuel injection ratio β, conversion factor n, and gaseous expansion coefficient at the steps S412 and S413:

TAU1=tTAU×KV×β (7)

TAU2=tTAU×n×(273+TT)/(273+25)×(1.β) (8)

Simultaneously, the incrementing procedures begin for the count value CVAPER of the fuel injection counter and the fuel injection ratio β. The fuel injection ratio β is set to zero during the initialization process of the ECU 40 and will be incremented by a certain value (e.g., 0.01) at a certain time interval (e.g., 50 ms) when the fuel injection by the first injector 21 begins.

Since the fuel injection ratio β is used for determination of the fuel injection time of both injectors 21 and 28, the ratio of the fuel injected by the first injector 21 increases gradually after the initiation of the fuel injection by the first injector 21 begins. As a result, the ratio of the fuel injected by the second injector 28 decreases gradually. Thus, the fuel injection ratios of the injectors 21 and 28 will be changed in proportion to the degree of reduction of the vapor in the fuel passage due to the fuel injection of the first injector 21.

At step S414, a determination is made as to whether the fuel injection ratio β is at its upper limit “1”. If it is determined that β=1 (step S414: YES), it is understood that no more fuel injection will be executed by the second injector 28. Then the second injector usage flag X2INJ will be turned off.

On the contrary, if it is determined that β≠1 (step S414: NO), it jumps to the step S416. At the step S416, a determination is made as to whether the count value CVAPER of the injection time counter of the first injector 21 is higher than its upper limit Ta. In the case where CVAPER≧Ta (step S416: YES), the count value CVAPER is set as CVAPER=1 (step S417). On the contrary, if the count value CVAPER is lower than the upper limit Ta (step S416: NO), the process of this routine is stopped for the time being. In other words, the processes of steps S416 and S417 guard the count value CVAPER at the upper limit Ta.

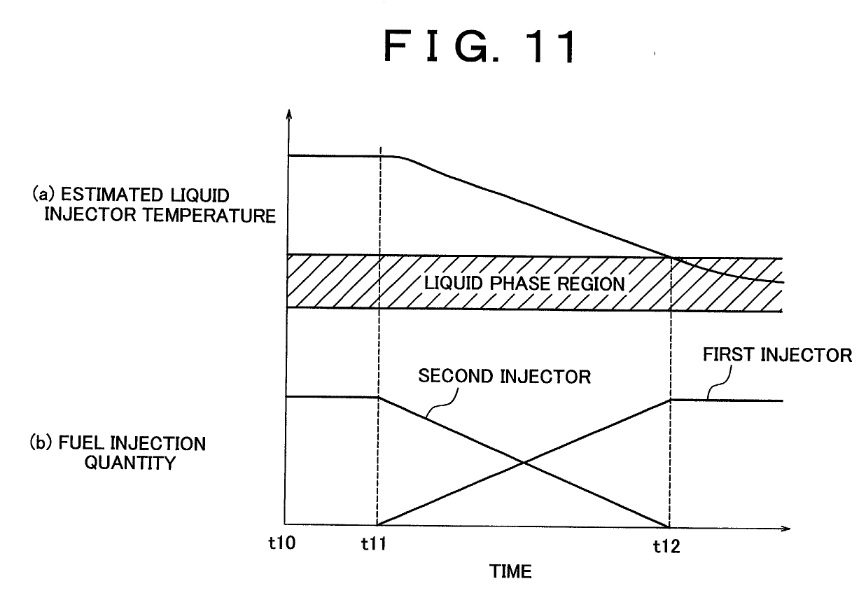

When the fuel injection times for the injectors 21 and 28 are determined as described above, this routine is terminated for the time being. Let us describe in the following referring to FIG. 11 about the chronological changes of the fuel injection quantities of the first injection 21 and the second injector 28, for which the fuel injection times are determined, when the engine 11 is restarted while it is still at a high temperature.

FIG. 11 shows an example of the chronological changes of the fuel injection quantities of the injectors 21 and 28 when the engine to which the system of the present invention is applied is restarted while it is still hot. When the engine 11 is restarted when it is still hot (timing t10, FIG. 11), a large quantity of vapor exists in the fuel passage (YES for the step S206 of FIG. 7), and the vapor in the fuel passage has not been scavenged (NO for both the steps S304 and S305 of FIG. 8), so that the fuel injection begins with only the second injector 28. The estimated first injector temperature Tinj1 is high in this case.

As the fuel injection by the second injector 28 continues, the temperature of the fuel in the fuel passage drops, and the vapor quantity in the fuel passage also reduces in accordance with this drop. When it is determined that the vapor in the fuel passage has been scavenged (YES for both the steps S304 and S305 of FIG. 8), the fuel injection begins from both injectors 21 and 28 (timing t11, FIG. 11). Also, as the fuel injection by the first injector 21 begins, the fuel injection ratio β begins to be incremented.

As time goes on, the fuel injection time TAU1 of the first injector 21 gradually becomes longer, and the fuel injection time TAU2 of the second injector 28 gradually becomes shorter, thus reducing the quantity of fuel injection. Simultaneously, heat exchange occurs between the first injector 21 and the fuel that is being supplied to the first injector 21, so that the estimated first injector temperature Tinj1 gradually drops (timing t11˜timing t12).

When the estimated first injector temperature Tinj1 becomes sufficiently small and the fuel injection ratio β becomes β=1, the fuel will be injected only by the first injector 21 (timing t12, in FIG. 11).

The system of this embodiment described in the above is capable of maintaining a high level of accuracy in controlling the fuel injection quantities of the first injector 21 and the second injector 28 in a system where the first injector and the second injector are used simultaneously, as the quantity of vapor generation in the fuel passage (vapor correction factor KV) is determined and the injection quantities of the injectors 21 and 28 are adjusted according to the determined quantity of vapor generation and the fuel pressure (fuel delivery pressure DP) in the fuel passage. Moreover, the system construction is simple as no device is required for vaporizing the fuel.

Furthermore, as the quantity of vapor generation (vapor correction factor KV) is determined by taking the fuel properties in the fuel tank 22 into consideration, the condition of the fuel injected by the first injector 21 is captured more accurately. As a result, the quantity of fuel injection of each injector can be adjusted more accurately.

As the fuel temperature TT and the fuel pressure TP in the fuel tank are detected, the properties of the fuel in the fuel tank 22 can be more easily determined based on the in-tank fuel temperature TT and the in-tank fuel pressure TP.

As the fuel is injected only by the first injector 21 while the vapor in the fuel passage is being scavenged, it is possible to inject the fuel in a liquid state, which can be adjusted more accurately than fuel in a gaseous state when the quantity of vapor in the fuel is smaller, in other words, the insufficiency of the quantity of the fuel injected by the first injector 21 is small. Thus, the adjustment of the injected fuel quantity can be controlled more accurately.

Moreover, it is possible to know more accurately whether any vapor exists in the fuel passage more accurately by determining whether the vapor in the fuel passage is scavenged based on the fuel delivery pressure DP and the fuel delivery temperature DT.

It is also possible to maintain a high level of accuracy in the adjustment of the quantity of fuel injection by determining whether the vapor in the fuel passage has been scavenged, and selecting between injecting the fuel only through the first injector 21 or through both injectors 21 and 28 based on the determination.

The quantity of fuel injection is adjusted by injecting the fuel only through the second injector 28 if the vapor quantity in the fuel passage is large, in other words, if the insufficiency of the quantity of fuel injection of the first injector 21 is substantial. Further, after the insufficiency of the quantity of fuel injection of the first injector 21 has lessened because of the continued fuel injection by the second injector 28, the fuel injection by the first injector 21 is used simultaneously. Consequently, the fuel injection quantities of the injectors 21 and 28 can be adjusted in a mode that depends more on the condition of the fuel supplied to the first injector 21.

It is also possible to gradually increase the quantity of fuel injection of the first injector 21 by means of increasing the ratio of the fuel to be injected by the first injector 21 after the fuel injection by the first injector 21 has begun by means of using the fuel injection ratio β for the determinations of the fuel injection times of both injectors 21 and 28. Consequently, the ratio of fuel injection by the first fuel injector 21 can be increased in accordance with the degree of reduction of the vapor quantity in the fuel passage caused by the fuel injection by the first injector 21.

It is also possible to estimate the temperature of the first injector 21 more accurately compared to the case of estimating the temperature based only on the cooling water temperature THW by means of estimating the first injector temperature Tinj1 based on the cooling water temperature THW and the fuel delivery temperature DT.

The invention can also be applied to internal combustion engines using fuels having lower boiling temperatures such as natural gas, methanol, ethanol and dimethylether.

It is also possible to specify fuel properties based on the comparison between the ratio of the intake air quantity and the quantity of fuel injection and the air/fuel ratio of the air/fuel mixture that is actually used in the internal combustion engine. A “discrepancy” develops between the quantity of fuel injection to be injected by the valve opening time of the first injector and the actual quantity of fuel injection due to the fuel properties, which in turn causes another “discrepancy” in the air/fuel ratio of the air/fuel mixture to be combusted in the internal combustion engine. Therefore, by detecting this “discrepancy,” it is possible to estimate the properties of the fuel supplied to the first injector. It is particularly advantageous to an internal combustion engine, which is equipped with an air/fuel mixture control device, because it is not necessary to add any new component to accomplish this goal.

The invention should not be construed as limited to the embodiment described above. The invention can be materialized by various other forms or styles without deviating from the spirit of the invention.

What is claimed is:

1. A fuel injection system for internal combustion engines comprising:
a fuel tank;
a first injector that supplies fuel stored in the fuel tank to an internal combustion engine in a liquid phase;
a second injector that supplies fuel stored in the fuel tank to the internal combustion engine in a gaseous phase; and
a controller that estimates the temperature of the first injector based on the temperature of the internal combustion engine and fuel temperature inside a fuel passage from the fuel tank to the first injector, and which adjusts fuel injection quantities of the first and second injectors in accordance with the fuel quantity required by the internal combustion engine based on the estimated temperature of the first injector.

2. The system according to claim 1, wherein the controller further determines the quantity of vapor generated in the fuel passage based on the estimated temperature of the first injector and fuel pressure in the fuel passage, and adjusts the fuel injection quantities of the first and second injectors based on the determined quantity of the generated vapor.

3. The system according to claim 2, wherein the quantity of generated vapor is determined based on properties of the fuel in the fuel tank.

4. A system according to claim 3, wherein the properties of the fuel are determined based on fuel temperature and fuel pressure in the fuel tank.

5. A system according to claim 2, wherein the controller sets the quantity of fuel injection of the second injector to zero when the quantity of generated vapor is less than a predetermined value.

6. A system according to claim 3, wherein the controller sets the quantity of fuel injection of the second injector to zero when the quantity of generated vapor is less than a predetermined value.

7. A system according to claim 4, wherein the controller sets the quantity of fuel injection of the second injector to zero when the quantity of generated vapor is less than a predetermined value.

8. A system according to claim 5, wherein the controller further estimates presence of vapor in the fuel passage based on fuel temperature and fuel pressure in the fuel passage, and adjusts the quantities of fuel injected by the first and second injectors depending on the estimated presence or absence of the vapor when the quantity of generated vapor is more than a predetermined value.

9. A system according to claim 8, wherein the controller sets the quantity of fuel injection of the first injector to zero if it is estimated that vapor exists in the fuel passage, and initiates fuel injection first with the first injector when it is estimated that there is no vapor in the fuel passage, gradually increases the ratio of the quantity of fuel injection of the first injector relative to the second injector in accordance with the required fuel quantity.

10. A fuel injection method for internal combustion engines comprising:
injecting fuel stored in the fuel tank into an internal combustion engine in a liquid phase by means of a first injector;
injecting stored in the fuel tank into an internal combustion engine in a gaseous phase by means of a second injector;
estimating the temperature of the first injector based on temperature of the internal combustion engine and fuel temperature inside a fuel passage from the fuel tank to the first injector; and
adjusting fuel injection quantities of the first and second injectors in accordance with a fuel quantity required by the internal combustion engine based on the estimated temperature of the first injector.

11. A method according to claim 10 further comprising:
determining the quantity of vapor generated in the fuel passage based on the estimated temperature of the first injector and fuel pressure in the fuel passage, and
adjusting the fuel injection quantities of the first and second injectors based on the determined quantity of the generated vapor.

12. A method of claim 11, wherein the quantity of generated vapor is determined based on properties of the fuel in the fuel tank.

13. A method of claim 12, wherein the properties of the fuel are determined based on fuel temperature and fuel pressure in the fuel tank.

14. A method of claim 11 further comprising setting the quantity of fuel injection of the second injector to zero when the quantity of generated vapor is less than a predetermined value.

15. A method of claim 12 further comprising setting the quantity of fuel injection of the second injector to zero executed by the controller when the quantity of generated vapor is less than a predetermined value.

16. A method of claim 13 further comprising the step of setting the quantity of fuel injection of the second injector to zero executed by the controller when the quantity of generated vapor is less than a predetermined value.

17. A method of claim 5 further comprising:
estimating whether or not vapor exits in the fuel passage based on the fuel temperature and fuel pressure in the fuel passage; and
adjusting fuel injection quantities of the first and second injectors depending on the estimated presence or absence of vapor when the determined quantity of vapor generation is more than a predetermined value.

18. A method of claim 17 further comprising:
setting the quantity of fuel injection of the first injector to zero when it is estimated that vapor exists in the fuel passage; and
initiating fuel injection first with the first injector when it is estimated that there is no vapor in the fuel passage, and gradually increasing the ratio of the quantity of fuel injection of the first injector relative to the second injector in accordance with the required fuel quantity.
